(19) United States
(12) Patent Application Publication
(10) Pub. No.: US 2014/0065050 A1
(43) Pub. Date: Mar. 6, 2014

(54) SYSTEMS, METHODS AND COMPOSITIONS FOR THE PRODUCTION OF SILICON NITRIDE NANOSTRUCTURES

(71) Applicant: Joan Bakalar, Waiwhetu, Lower Hutt (NZ)

(72) Inventors: Anthony Heathcote Clemens, Waiwhetu (NZ); John Spencer, Kelburn (NZ); Murray McCurdy, Kelburn (NZ); Troy Dougherty, Kelburn (NZ)

(73) Assignee: CRL Energy Limited, Lower Hutt (NZ)

(21) Appl. No.: 13/814,208

(22) PCT Filed: Aug. 2, 2011
(86) PCT No.: PCT/NZ2011/000149

§ 371 Date: Sep. 11, 2013

Related U.S. Application Data
(60) Provisional application No. 61/370,071, filed on Aug. 2, 2010.

(30) Foreign Application Priority Data
Aug. 6, 2010 (NZ) 587249
Nov. 23, 2010 (NZ) 589459

(51) Int. Cl. C01B 21/068

(52) U.S. Cl. CPC C01B 21/068
USPC 423/344

(57) ABSTRACT

Systems, methods and compositions for the production of silicon nitride nanostructures are herein disclosed. In at least one embodiment, a carbon feedstock is preprocessed, combined with a silicon feedstock and annealed in the presence of a nitrogen containing compound to produce a silicon nitride nanostructure.

### CROSS REFERENCE TO RELATED APPLICATIONS

This application claims priority from U.S. provisional application No. 61/370,071, entitled “SYSTEMS, METHODS AND COMPOSITIONS FOR THE PRODUCTION OF SILICON NITRIDE NANOSTRUCTURES,” filed on Aug. 2, 2010; New Zealand provisional application no. NZ 587249, entitled “SYSTEMS, METHODS AND COMPOSITIONS FOR THE PRODUCTION OF SILICON NITRIDE NANOSTRUCTURES” filed on Aug. 6, 2010; and New Zealand provisional application no. NZ 589459, entitled “SILICON NITRIDE NANOWIRES” filed on Nov. 23, 2010, which are all incorporated by reference in their entirety, for all purposes, herein.

### FIELD OF TECHNOLOGY

The present application is directed to systems, methods and compositions for the production of silicon nitride nanostructures.

### BACKGROUND

Silicon nitride (Si₃N₄ or SiN) has been the subject of substantial research due to its remarkable thermal, mechanical and chemical properties. Silicon nitride is well suited for many applications and environments including corrosive and high temperature environments. With the emergence of nanotechnology, there has been new interest in producing silicon nitride nanostructures as reinforcing material and for advanced applications in electronics and optoelectronics.

Silicon nitride can exist as the following crystalline polymorphs: α-Si₃N₄, β-Si₃N₄ and γ-Si₃N₄. The β-phase and β-phase have hexagonal symmetry consisting of corner shared SiN₄ tetrahedron. The α-phase and β-phase consist of different layers of stacked Si and N atoms. The α-phase consists of stacked ABCD layers with the CD layers related to the AB layers by a shill along the c-axis of the unit cell. The β-phase consists of alternating ABAB layers. The ABCD stacking gives rise to two interstitial cavities in the unit cell of the α-phase and produces tunnels running parallel to the c-axis in the β-phase. The more recently discovered γ-phase of Si₃N₄ consists of a spinel-type structure with cubic symmetry. Two silicon atoms are octahedrally coordinated into six nitrogen atoms and one silicon atom is tetrahedrally coordinated.

The α-phase and β-phase are easily produced at high temperatures under normal nitrogen pressures. The transition temperature between the two phases occurs at ˜1400° C. Heating of the α-phase at or above the transition temperature causes a transformation into the β-phase. However, the γ-phase can only be formed at high temperatures and pressures. Therefore, the β-phase is considered the thermodynamic phase, while the α-phase and γ-phases are meta-stable.

Many techniques have been employed to produce silicon nitride nanostructures in the laboratory. Current methods for producing silicon nitride nanostructures use expensive raw products require high reaction temperatures to promote the growth of the nanostructure. The selectivity of the resulting nanostructure product is difficult to control with the use of current methods.

Improved systems, methods and compositions for the production of silicon nitride nanostructures are herein disclosed.

### SUMMARY

Systems, methods and compositions for the production of silicon nitride nanostructures are herein disclosed. In at least one embodiment, a carbon feedstock is preprocessed, combined with a silicon feedstock and annealed in the presence of a nitrogen containing compound to produce a silicon nitride nanostructure.

The foregoing and other objects, features and advantages of the present disclosure will become more readily apparent from the following detailed description of exemplary embodiments as disclosed herein.

### BRIEF DESCRIPTION OF THE DRAWINGS

Embodiments of the present application are described, by way of example only, with reference to the attached Figures, wherein:

FIG. 1 illustrates a flow chart of an exemplary process for preprocessing a carbon feedstock according to one embodiment;

FIG. 2 illustrates a flow chart of an exemplary process for preprocessing a silicon feedstock according to one embodiment;

FIG. 3 illustrates a flow chart of an exemplary process for preprocessing a silicon feedstock according to another embodiment;

FIG. 4 illustrates a flow chart of an exemplary process for the production of silicon nitride nanostructures according to one embodiment;

FIG. 5 illustrates exemplary silicon nitride nanostructures produced according to one embodiment;

FIG. 6 illustrates exemplary silicon nitride nanostructures produced according to another embodiment; and

FIG. 7 illustrates exemplary silicon nitride nanostructures produced according to another embodiment.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, methods, procedures and components have not been described in detail so as not to obscure the embodiments described herein.

Systems, methods and compositions for the production of silicon nitride nanostructures are herein disclosed. Exemplary feedstock can include a carbon feedstock and a silicon feedstock. The carbon and silicon feedstock are processed or pre-treated prior to one or more primary processing steps. In a primary processing step, the combined and pre-treated carbon and silicon feedstock is heated, reacted or annealed in the presence of a nitrogen containing compound to produce one or more silicon nitride nano structures.

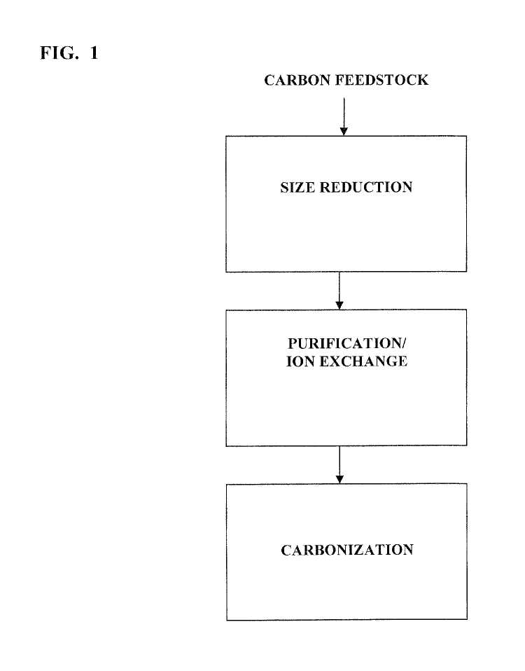

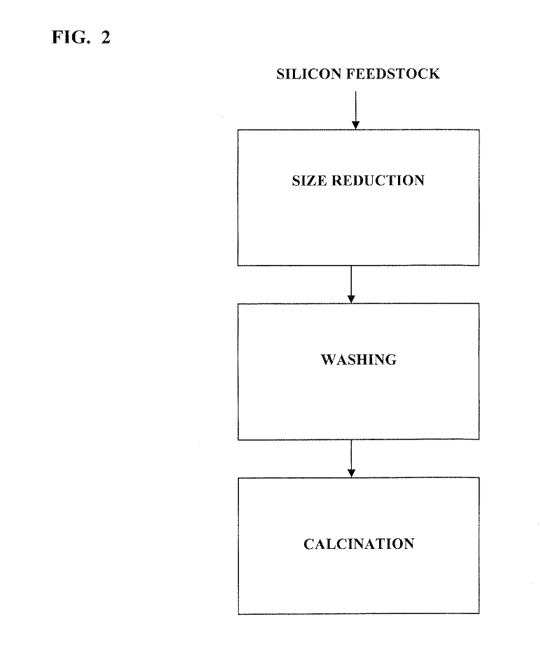

The carbon feedstock and the silicon feedstock can be pre-treated in a semibatch or continuous process as described below in reference to FIGS. 1-2. The carbon feedstock and the silicon feedstock can be pre-treated separately or together in the same semibatch or continuous process. The carbon and silicon feedstock can be combined and pretreated by reducing particle size distributions or other pre-processing steps below in reference to FIGS. 1-2.

### 1. Preprocessing of Carbon Feedstock

FIG. 1 illustrates a flow chart of an exemplary process for preprocessing a carbon feedstock according to one embodiment.

The carbon feedstock is a feedstock capable of providing a viable long term source of carbon for industrial scale production of silicon nitride nanostructures. The carbon feedstock can include, but is not limited to lignite, sub-bituminous coal, bituminous coal, anthracite, graphite, sugar, wood, organic material, organic waste, carbon monoxide gas, natural gas, porous carbon, activated carbon, pitch, char, and combinations thereof. Lignite is particularly cheap and easy to pre-treat or pre-process.

The carbon feedstock herein disclosed can contain particles having a particle size distribution. The particle size distribution of the carbon feed stock can be reduced to enhance ion exchange. During particle size reduction, the carbon feedstock can be in solid form, powder form or slurry form.

The carbon feedstock can be converted to slurry form by combining the feedstock with water or an organic solvent. Organic solvents can include, but are not limited to ethanol, pyridine, toluene, naphtha, hexane, kerosene, paraffinic solvents and other hydrocarbon solvents compatible with the carbon feedstock.

The particle size distribution of the carbon feedstock can be reduced with a jaw crusher, hammer mill, ball mill, ring mill or other method known in the art for reducing the size of solid particles. In an exemplary embodiment, the particle size distribution of the carbon feedstock can be reduced to a size of less than or equal to 10 mm, preferably less than or equal to 5 mm or more preferably less than or equal to 3 mm.

In an exemplary embodiment, the particle size distribution of the carbon feedstock is reduced with a ring mill by ring milling. In another exemplary embodiment, the particle size distribution of the carbon feedstock is reduced by jaw crushing, hammer milling, ball milling or ring milling for less than or equal to 5 minutes. In another exemplary embodiment, the particle size distribution of the carbon feedstock is reduced by crushing, hammer milling, ball milling or ring milling to a size of less than or equal to 1 mm.

In a preferred embodiment, the particle size distribution of the carbon feedstock is reduced in a continuous ring milling process with the use of a tungsten carbide or steel ring mill for less than or equal to 5 minutes to a particle size distribution of less than or equal to 1 mm.

The degree of purification of the carbon feedstock can affect the yield, selectivity, purity, electronic properties, magnetic properties, optical properties and/or physical properties of the resulting silicon nitride nanostructure produced. For instance, β-Si₃N₄, shown generally as structure (I) below, exhibits enhanced thermal stability, shock resistance and fracture toughness. Therefore, in certain applications, β-Si₃N₄ is desired over α-Si₃N₄.

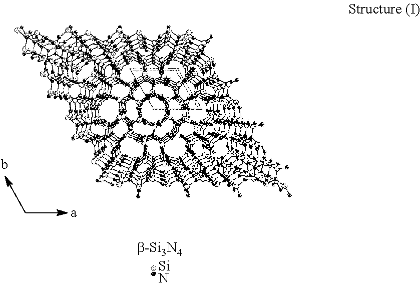

α-Si3N4, shown in structure (II) below, is preferred for bulk applications and is easier to produce.

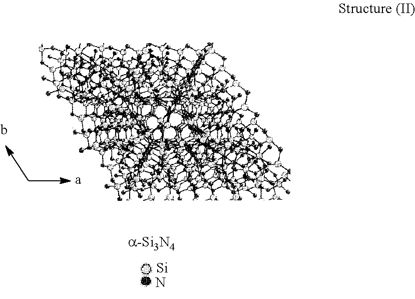

The carbon feedstock can be purified in one or more purification steps disclosed herein including, but not limited to ash removal, demineralization, swelling and ion exchange. The extent and method of purification can be used to modify or control the yield, selectivity, purity, electronic properties, magnetic properties, optical properties and/or mechanical properties of the resulting silicon nitride nanostructure produced. The purification steps disclosed herein can be performed separately or simultaneously.

Excess ash, minerals and other impurities can be removed from the carbon feedstock through separation processes including, but not limited to decantation, solid phase extraction, filtration, froth flotation (surface properties) or gravity separation using centrifuges or cyclones. A float and sink analysis and procedure can be performed to achieve an optimal yield of ash removal by separating heavier ash from a floating layer of purified carbon feedstock. The removal of ash and other impurities from the carbon feedstock prior to reaction with the silicon feedstock reduces or eliminates post purification steps including the need for acid washing of the resulting silicon nitride nanostructure.

Optionally, the demineralization of the carbon feedstock can be performed simultaneously with ash removal by treating or combining the feedstock with a demineralization solvent. Demineralization solvents can include potassium hydroxide (KOH), sodium hydroxide (NaOH), sulfuric acid (H₂SO₄) or other solvents capable of dissociating inorganic impurities, sands, clays or minerals from the carbon feedstock. Inorganic impurities, sands, clays and minerals can be removed through decantation, solid phase extraction, filtration, gravity separation, froth flotation or other separation means.

Optionally, particles within the carbon feedstock can be swelled with a swelling agent separately from or simultaneously with the ash removal and demineralization steps. Suitable swelling agents include, but are not limited to water, ammonia, butylamine, propylamine, N-methyl-2-pyrollidone, ethylene diamine, carbon dioxide, butane, ethanol, pyridine, toluene, naphtha, hexane, kerosene, paraffinic solvents, other organic solvents capable of swelling the carbon feedstock and combinations thereof.

Inorganic impurities, such as ash, sand, clay and minerals are more readily removed or separated from the carbon feedstock after swelling the feedstock. Impurities can be separated or removed from the carbon feedstock through decantation, solid phase extraction, filtration, gravity separation, froth flotation or other separation means after swelling. The swelling agent can be removed or separated from the carbon feedstock to reduce the particle size distribution of the carbon feedstock.

The carbon feedstock can be subjected to ion exchange to replace or exchange elements including, but not limited to calcium, magnesium and aluminum with exchange ions. The carbon feedstock can be contacted with an aqueous ion exchange solution or a bed of resin containing ions that replace feedstock laden elements. Exchange ions can act as a catalyst and lower the activation energy of a product producing reaction in a subsequent primary processing step. Water, organic or other hydrocarbon solvents including ethanol can be used to make the aqueous exchange solution. Suitable exchange ions for exemplary aqueous exchange solutions include, but are not limited to the following ions: Fe, Zn, Cu, Pb, Co, Ni, Mn, Cr, Ga, K ions or combinations thereof. The exchange ions are preferably cations with a +2 charge, transition metals or other catalytic metal.

In an exemplary embodiment, Fe²⁺ is used as an exchange ion to replace one or more components or ions within the carbon feedstock. During purification of the carbon feedstock, exchanged Fe ions remain bound to the carbon feedstock and promote the productions of silicon nitride nanostructures by providing formation sites for nanostructure growth.

The carbon feedstock can swell during ion exchange due to contact with the aqueous ion exchange solution. Inorganic impurities, such as ash, sand, clay and minerals are more readily removed or separated from the carbon feedstock after swelling the feedstock. Impurities such as ash sand, clay and minerals can be separated or removed from the carbon feedstock through decantation, solid phase extraction, filtration, gravity separation or other separation means prior to, during or after ion exchange. The ion exchange solution can also be removed or separated from the carbon feedstock after ion exchange to reduce the particle size distribution of the carbon feedstock.

The exchange ions can be catalytic ions used to modify and control the yield, selectivity and purity of the resulting silicon nitride nanostructure. These ions act as dopants in the crystal structure and influence the growth of the crystal structure. The ratio of calcium, magnesium and aluminum left in the carbon feedstock is directly related to the size, particularly the width, of silicon nitride nanostructures formed in the resulting product. The amount of exchange ions, particularly Fe ions, bound to the carbon feedstock during ion exchange affects the rate of growth of nanostructures. An increase in the amount of bound Fe ions will increase the rate of nanostructure growth.

The following ion exchange parameters can be modified to control the ions interchanged during ion exchange, the extent of ion exchange and the rate of ion exchange: the pH of the aqueous solution or resin bed containing the exchange ions; the temperature at which ion exchange is conducted; the isoelectric point of ions being exchanged; the stirring rate used during ion exchange; the composition of the ion exchange solvent, the weight ratio of carbon feedstock to ion exchange solvent and the length of time over which ion exchange is performed. These ion exchange parameters can also be modified to control the yield, selectivity, purity, electronic properties, magnetic properties, optical properties and/or physical properties of the resulting silicon nitride nanostructures.

In an exemplary embodiment, the ion exchange is carried out at a temperature of less than or equal to 30° C. and preferably less than or equal to 20° C. In another exemplary embodiment, the ion exchange is carried out at a temperature of less than or equal to 30° C. and preferably less than or equal to 20° C. for a period of greater than 24 hours. In yet another exemplary embodiment, the ion exchange is carried out at a temperature of about 70° C.

Additionally, the carbon feedstock can be subjected to drying and pyrolysis/carbonization to char the carbon feedstock and eliminate any residual volatile matter including, but not limited to hydrogen and oxygen containing compounds. The pyrolysis or carbonization can be performed in an oxygen free atmosphere, including but not limited to a nitrogen atmosphere, a substantial vacuum, a waste gas atmosphere or other inert or oxygen free gas atmosphere. In an exemplary embodiment, the pyrolysis is preferably conducted in a nitrogen atmosphere.

During pyrolysis or carbonization, the bond between exchange ions and the carbon feedstock are broken and the exchange ions become free metals or metal oxides. By-products from pyrolysis or carbonization including coal, gas or oil can be recovered and recycled in some cases for use as carbon feedstock. The resulting feedstock can contain char with high carbon content and dispersed exchange ions used to increase the catalytic activity of the carbon feedstock.

The pyrolysis or carbonization can be carried out in a heated tube, reactor, furnace, rotary kiln or other apparatus suitable for heating material in an oxygen free atmosphere. In an exemplary embodiment, the pyrolysis or carbonization is conducted within a temperature range of 300-1000° C. or higher for between 30 seconds and 5 hours under a flow of nitrogen. In another exemplary embodiment, the pyrolysis or carbonization is conducted within a temperature range of 400-600° C. or higher for 5-30 hours under a flow of nitrogen. In another exemplary embodiment, the pyrolysis is conducted within a temperature range of 600-1000° C. or higher for 1-5 hours under a flow of nitrogen. In another exemplary embodiment, the pyrolysis is conducted within a temperature range of 700-900° C. or higher for 1-5 hours under a flow of nitrogen. In yet another exemplary embodiment, the pyrolysis or carbonization is conducted at a temperature range of about 500° C. for 1 to 5 hours under a flow of nitrogen. Pyrolysis is preferably performed at atmospheric pressure but can also be performed at lower and high pressures.

In a preferred embodiment, the carbon feedstock is a lignite source that undergoes ion exchange and pyrolysis or carbonization to produce a pre-treated carbon feedstock comprising char with high carbon content and dispersed Fe²⁺ exchange that increase the catalytic activity of the carbon feedstock.

The particle size distribution of the carbon feedstock can preferably be reduced again before combination with the silicon feedstock. Particle size can be reduced with a jaw crusher, hammer mill, ball mill, ring mill or other method known in the art for reducing the size of solid particles. In an exemplary embodiment, the size of particles are preferably reduced to a size less than or equal to 100 μm, more preferably less than or equal to 30 μm.

During particle size reduction, the carbon feedstock can be in solid form, powder form or slurry form. The carbon feedstock can be converted to slurry form by combining the feedstock with water or an organic solvent. Organic solvents can include, but are not limited to ethanol, pyridine, toluene, naphtha, hexane, kerosene, paraffinic solvents and other hydrocarbon solvents compatible with the carbon feedstock.

In an exemplary embodiment, the particle size distribution of the carbon feedstock is preferably reduced with a ball mill by ball milling in either air, N₂, CO₂, another suitable gas, or with the carbon feedstock in slurry form. In another exemplary embodiment, the particle size distribution of the carbon feedstock is preferably reduced with a ball mill by ball milling for 2-72 hours. In another exemplary embodiment, the particle size distribution of the carbon feedstock is preferably reduced with a ring mill to a size of less than or equal to 1 mm. In another exemplary embodiment, the particle size distribution of the carbon feedstock is preferably reduced in a steel ball mill with steel balls for 6-24 hours in air or in a slurry containing water or an organic solvent.

In another exemplary embodiment, the particle size distribution of the carbon feedstock is preferably reduced with a ring mill by ring milling. In another exemplary embodiment, the particle size distribution of the carbon feedstock is preferably reduced with a ring mill to a size of less than or equal to 100 μm. In another exemplary embodiment, the particle size distribution of the carbon feedstock is preferably reduced in a steel ball mill with steel balls 6-24 hours in air or in a slurry containing water or an organic solvent.

Excess ash, minerals and other impurities naturally occurring in the carbon feedstock or created during pyrolysis/carbonization or other pre-processing step can be removed from the carbon feedstock through separation processes including, but not limited to decantation, solid phase extraction, filtration, froth flotation (surface properties) or gravity separation using centrifuges or cyclones. A float and sink analysis and procedure can be performed to achieve an optimal yield of ash removal by separating heavier ash from a floating layer of purified carbon feedstock. The removal of ash and other impurities from the carbon feedstock prior to reaction with the silicon feedstock reduces or eliminates post purification steps including the need for acid washing of the resulting silicon nitride nanostructure.

Optionally, the demineralization of the carbon feedstock can be performed simultaneously with ash removal by treating or combining the feedstock with a demineralization solvent. Demineralization solvents can include potassium hydroxide (KOH), sodium hydroxide (NaOH), sulfuric acid (H₂SO₄) or other solvents capable of dissociating inorganic impurities, sands, clays or minerals from the carbon feedstock. The inorganic impurities, sands, clays and minerals can be removed through decantation, solid phase extraction, filtration, gravity separation, froth flotation or other separation means.

### 2. Preprocessing of Silicon Feedstock

FIG. 2 illustrates a flow chart of an exemplary process for preprocessing a silicon feedstock according to one embodiment.

The silicon feedstock can include, but is not limited to high purity microsilica, sand, ash, microporous silica, geosilica, diatomite, mined silica, fumed silica, sub-mm silica and waste silica including geothermal waste silica, rice hull, glass and combinations thereof.

The silicon feedstock herein disclosed can contain particles having a particle size distribution. The particle size distribution of the silicon feed stock can be reduced in one or more pre-treatment steps. The silicon feedstock can be converted to slurry form by combining the feedstock with water or an alkali metal salt of silicon dioxide. Other suitable solvents for forming a silicon feedstock slurry include metal acid caustic solutions or metal containing solutions containing at least one of the following ions: Fe, Zn, Cu, Pb, Co, Ni, Mn, Cr, Ga, K ions or combinations thereof. During particle size reduction, the silicon feedstock can be in solid form, powder form or slurry form.

The particle size distribution of the silicon feedstock can be reduced with a jaw crusher, hammer mill, ball mill, ring mill, combinations thereof or other method known in the art for reducing the size of solid particles. In an exemplary embodiment, the particle size distribution of the silicon feedstock is reduced to a size of less than or equal to 50 microns, preferably less than 10 microns.

In an exemplary embodiment, the particle size distribution of the silicon feedstock is preferably reduced with a ring mill by ring milling. In another exemplary embodiment, the particle size distribution of the silicon feedstock is preferably reduced with a ring mill by ring milling for less than or equal to 5 minutes. In another exemplary embodiment, the particle size distribution of the silicon feedstock is preferably reduced with a ring mill to a size of less than or equal to 50 microns, preferably less than 10 microns. In another exemplary embodiment, the particle size distribution of the silicon feedstock is preferably reduced to a range between 20 to 60 microns. In another exemplary embodiment, the particle size distribution of the silicon feedstock is reduced in a continuous ring milling process with the use of a tungsten carbide or steel ring mill.

In an exemplary embodiment, the silicon feedstock can be a high purity microsilica that requires no particle size reduction.

The silicon feedstock can be washed with an aqueous acid solution to remove impurities including, but not limited to Na, Ca, Mn, Al, C, Mg, Fe, B, P, Ti and As. The aqueous acid solution dissociates heavy metals and other impurities from the silicon feedstock. The impurities typically dissociate as dissolved salts. The aqueous acid solution can contain at least one of the following compounds: water, hydrochloric acid, hydrofluoric acid, sulfuric acid, sulfurous acid, nitric acid or other acid capable of removing or dissociating impurities from the silicon feedstock. The impurities can be removed through decantation, solid phase extraction, filtration, gravity separation, evaporation, ion chromatography or other separation means. The aqueous acid can be recovered or regenerated through evaporation, filtration, gravity separation, sparging or other regeneration means.

The silicon feedstock can also be rinsed with water, dried, calcined and/or heat-treated above ambient temperature to facilitate further removal or dissociation of impurities and to remove any aqueous solution or acid from the washing step. Any additional impurities can be removed through decantation, solid phase extraction, filtration, gravity separation, ion chromatography or other separation means to produce a higher purity silicon feedstock.

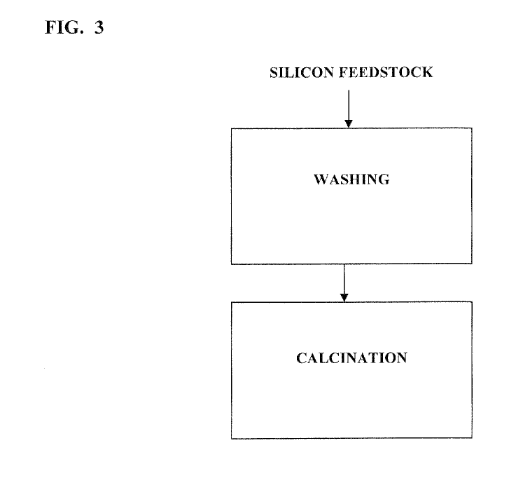

FIG. 3 illustrates a flow chart of an exemplary process for preprocessing a silicon feedstock according to another embodiment. The silicon feedstock can be high purity microsilica that requires no particle size reduction. In most cases, acid washing of high purity microsilica feedstock is not necessary.

If necessary, the high purity microsilica feedstock can be washed with an aqueous acid solution to remove impurities including, but not limited to Na, Ca, Mn, Al, C, Mg, Fe, B, P, Ti and As. The aqueous acid solution dissociates heavy metals and other impurities from the silicon feedstock. The impurities typically dissociate as dissolved salts. The aqueous acid solution can contain at least one of the following compounds: water, hydrochloric acid, hydrofluoric acid, sulfuric acid, sulfurous acid, nitric acid or other acid capable of removing or dissociating impurities from the silicon feedstock. The impurities can be removed through decantation, solid phase extraction, filtration, gravity separation, evaporation, ion chromatography or other separation means. The aqueous acid can be recovered or regenerated through evaporation, filtration, gravity separation, sparging or other regeneration means

The silicon feedstock can also be rinsed with water, dried, calcined and/or heat-treated above ambient temperature to facilitate further removal or dissociation of impurities and to remove any aqueous solution or acid from the washing step. Any additional impurities can be removed through decantation, solid phase extraction, filtration, gravity separation, ion chromatography or other separation means to produce a higher purity silicon feedstock.

### 3. Production of Silicon Nitride Nanostructures

The pretreated carbon feedstock and silicon feedstock can be combined or reacted by annealing with a nitrogen containing compound to produce silicon nitride nanostructures including but not limited to nanowires, nanobelts, nanowhiskers or nanoribbons composed of at least one of: silicon, nitride, silicon oxynitride, silicon carbide, SiALON, or other composite silicon nitride product. The entire pre-treating and annealing process can be performed in a semibatch or continuous manner.

The carbon feedstock and the silicon feedstock can be pre-treated in a semibatch or continuous process as described above in reference to FIGS. 1-2. The carbon feedstock and the silicon feedstock can be pre-treated separately or together in the same semibatch or continuous process. The carbon and silicon feedstock can be combined and pretreated by reducing particle size distributions or other pre=processing steps above in reference to FIGS. 1-2.

A. Combining the Carbon Feedstock and Silicon Feedstock

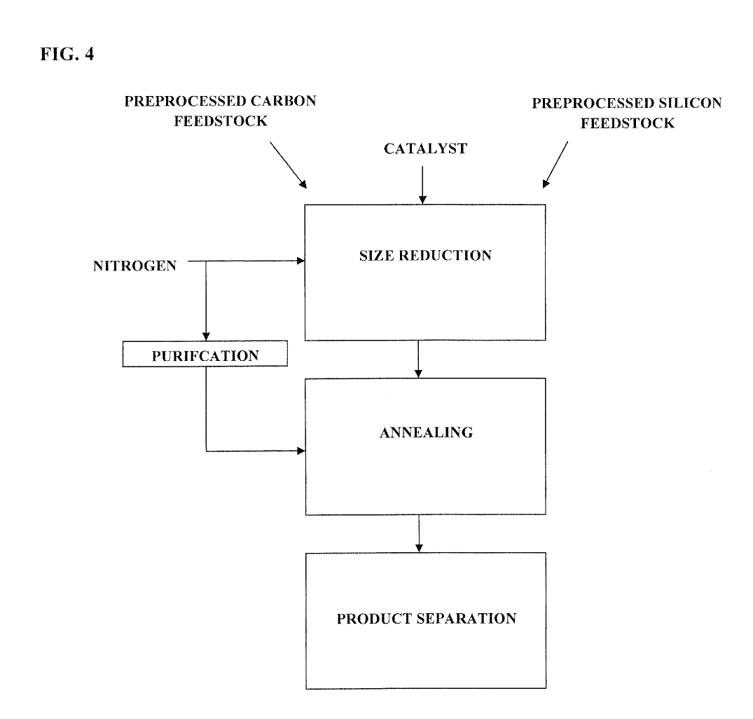

FIG. 4 illustrates an exemplary process for the production of silicon nitride nanostructures according to one embodiment.

The carbon feedstock and the silicon feedstock can be subjected to further size reduction after pre-treatment. The particle size distribution of the carbon feedstock and the silicon feedstock can be reduced together or in separate size reduction steps after preprocessing or as a substitute to preprocessing described in reference to FIGS. 1-2. A nitrogen containing compound can be introduced to create a nitrogen atmosphere during size reduction of the carbon and silicon feedstock. The particle size distribution of the carbon and silicon feedstock can be reduced with a jaw crusher, hammer mill, ball mill, ring mill, combinations thereof or other method known in the art for reducing the size of solid particles.

In an exemplary embodiment, the carbon feedstock and silicon feedstock are size reduced simultaneously after combining or separately in an air or nitrogen atmosphere at ambient temperature by ball milling for approximately 2 to 72 hours, preferably 6 to 24 hours, and ring milling for 20 to 3600 seconds, preferably 120 seconds, to produce a particle size distribution of about less than or equal to 30 microns in the carbon feedstock, silicon feedstock or both. The carbon feedstock, silicon feedstock or the combined carbon and silicon feedstock can be combined with water or an organic solvent, such as FeSO₄, to make a slurry which is milled to reduce the particle size distribution of the feedstock.

Additionally, the size reduced carbon feedstock, silicon feedstock or combined feedstock can be subjected to a leaching step before, after or during mixing or combining of the feedstock. Leaching may be necessary to purify or remove unwanted elements, ions or compounds from the carbon feedstock, silicon feedstock or combined feedstock.

Leaching can include reacting the carbon feedstock, silicon feedstock or combined feedstock in a chemical reactor with a sulphate gas. In an exemplary embodiment, the reactor is preferably a Continuous Stirred-Tank Reactor operating at 50-70° C.

A catalyst can be added to the combined feedstock or slurry. The catalyst can include at least one salt compound containing the following ions: Fe, Zn, Cu, Pb, Co, Ni, Mn, Cr, Ga, Pt, Pd, Au, Ru ions or combinations thereof. The catalytic ions are preferably cations with a +2 charge, transition metals or other catalytic metal. The catalytic ions are preferably added to the combined feedstock in an aqueous or organic solvent.

B. Annealing the Combined Feedstock

The combined carbon and silicon feedstock can be annealed or heated in the presence of a nitrogen containing compound.

The nitrogen containing compound can include, but is not limited to at least one of the following compounds: nitrogen gas, ammonia, urea, hydrogen, carbon monoxide, carbon dioxide, waste gas, other nitrogen containing gas, gas mixture or combinations thereof. In an exemplary embodiment, the nitrogen containing compound contains at least 20 percent by weight hydrogen gas in nitrogen, ammonia or urea.

The nitrogen containing compound can be purified before it is used during annealing of the combined carbon and silicon feedstock. The nitrogen containing gas can be purified with gas purification sieves, or other mechanical or chemical purification means.

The mixture of combined carbon and silicon feedstock and nitrogen containing compound is annealed in an annealing chamber to produce silicon nitride nanostructures including, but not limited to silicon nitride nanowires, nanobelts, nanowhiskers or nanoribbons composed of silicon nitride, silicon oxynitride, silicon carbide, SiALON or other silicon nitride containing compound.

The annealing chamber can be a furnace, oven, rotary kiln or other chamber suitable for annealing the feedstock in a nitrogen containing atmosphere. The annealing can occur in semibatch or continuous manner to allow for sufficient industrial scale production of silicon nitride nanostructures.

In an exemplary embodiment, the carbon feedstock is preferably lignite, the silicon feedstock is preferably sand and the nitrogen containing compound is nitrogen gas.

In another exemplary embodiment, the ratios by weight of silicon feedstock, carbon feedstock, and nitrogen containing compound is approximately 1:3-4:2. Relatively, less carbon and nitrogen is required to produce silicon oxynitride nanostructures and silicon carbide nanostructures. Therefore, the ratios by weight of silicon feedstock, carbon feedstock, and nitrogen containing compound can be modified to other ranges to produce a specific silicon nitride nanostructure.

In an exemplary embodiment, the annealing of combined carbon and silicon feedstock in the presence of a nitrogen containing compound can be conducted at a temperature of between 1300-1450° C. for 3-20 hours, preferably 8 hours. To produce silicon oxynitride nanostructures, an annealing temperature of between 1000-1250° C. for approximately 3 hours is used. To produce silicon carbide nanostructures, an annealing temperature of 1450-1600° C. for approximately 3 hours is used. Therefore, the composition, yield and selectivity of the resulting silicon nitride nanostructure can be controlled or modified by modifying at least one or more annealing parameters including, but not limited to the composition of combined carbon and silicon feedstock, the flow rate of the combined carbon and silicon feedstock, the annealing temperature or the time period over which annealing occurs. Annealing preferably occurs near atmospheric pressure between about 0.5 and 2 bar absolute.

In an exemplary embodiment, a combined carbon and silicon feedstock comprising pre-treated lignite and sand is annealed in the presence of a nitrogen containing compound at 1370° C. for a period of less than or equal to 3 hours to produce high purity silicon nitride nanostructures.

After annealing, residual carbonaceous material can be removed from the resulting silicon nitride nanostructure by heating the resulting nanostructure in air, exhaust gas or other gas atmosphere. Exhaust gases can be purified before use in removing residual carbonaceous material from the resulting silicon nitride nanostructure.

Optionally the resulting silicon nitride nanostructure comprising at least one of silicon, nitride, silicon, oxynitride, silicon carbide, SiALON, or other composite silicon nitride products produced herein can undergo further physical or chemical purification to modify the electronic, magnetic, mechanical or optical properties of the resulting silicon nitride nanostructure. This purification can optionally include an acid washing step, wherein the resulting silicon nitride nanostructure is acid washed with aqueous sodium hydroxide, hydrochloric acid, hydrofluoric acid or sulfuric acid to remove impurities. In an exemplary embodiment, the silicon nitride nanostructure is preferably washed with caustic sodium hydroxide.

Exhaust gases produced from annealing can be recycled and used in one or more other process steps herein disclosed including the pyrolysis or carbonization step of the carbon feedstock. Other waste gases or side products produced throughout the process steps herein disclosed can also be purified and/or recycled for use in one or more process steps disclosed herein. Recycled exhaust gas and other waste gases can potentially be used as feedstock. The pre-treating of feedstock and primary reaction steps including annealing can be conducted in a semibatch or continuous manner.

The resulting purified silicon nitride nanostructure is separated and recovered for use in one or more applications. The separated and purified product can be packaged and stored for later use. Silicon nitride nanostructures herein disclosed can be used for many applications including, but not limited to reinforcing materials, pultrusion, nanofluids metal matrix composites, ceramic composites, polymer composites, concrete composites, glass fiber reinforcement, discontinuous reinforcing, continuous reinforcing, oils, thin films, electrical applications, optical applications and other applications know in the art.

### EXAMPLES

The following examples are provided for illustrative purposes. The examples are not intended to limit the scope of the present disclosure and they should not be so interpreted.

### Example 1

### Synthesis of Silicon Nitride Nanostructure

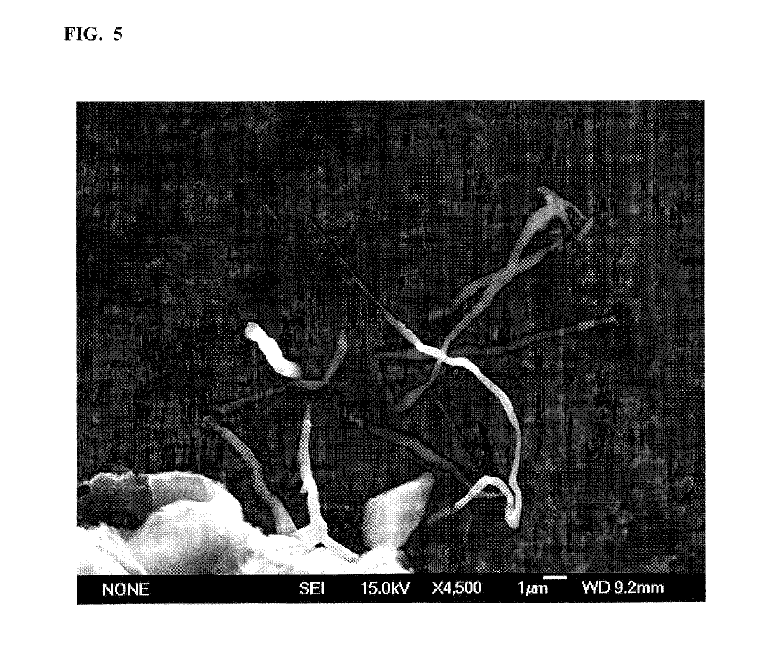

FIG. 5 illustrates exemplary silicon nitride nanostructures or fibers produced according to one embodiment. The exemplary silicon nitride nanostructure was produced from a combined carbon and silicon nitride feedstock of lignite comprising mineral ash as the silica source. The particle size distribution of the lignite feedstock was reduced by ball milling and ring milling the feedstock to produce a particle size distribution of about 3 mm. The feedstock was annealed at a temperature of 1370° C. for 4 hours in a continuous flow of nitrogen gas to produce the silicon nitride nanostructure fibers illustrated in FIG. 5.

### Example 2

### Synthesis of Silicon Nitride Nanostructure

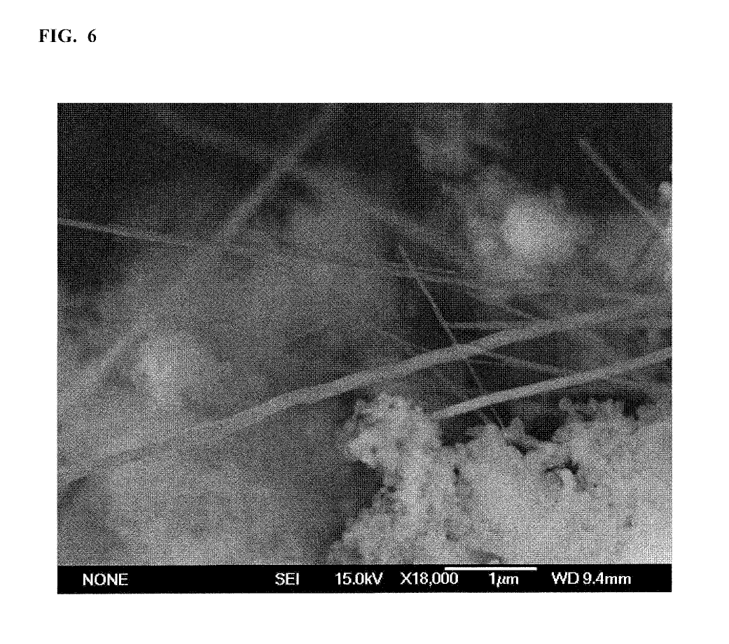

FIG. 6 illustrates exemplary silicon nitride nanostructures produced according to another embodiment. The exemplary silicon nitride nanostructure was produced from a combined carbon and silicon nitride feedstock of lignite comprising mineral ash as the silica source with additional silica added to the feedstock. The particle size distribution of the feedstock was reduced by ball milling and ring milling the feedstock to produce a particle size distribution of about 3 mm. The feedstock was annealed at a temperature of 1370° C. for 4 hours in a continuous flow of nitrogen gas to produce the silicon nitride nanofibers illustrated in FIG. 6. The yield of silicon nitride nanofibers shown in FIG. 6 was increased by including additional silica in the feedstock.

### Example 3

### Synthesis of Silicon Nitride Nanostructure

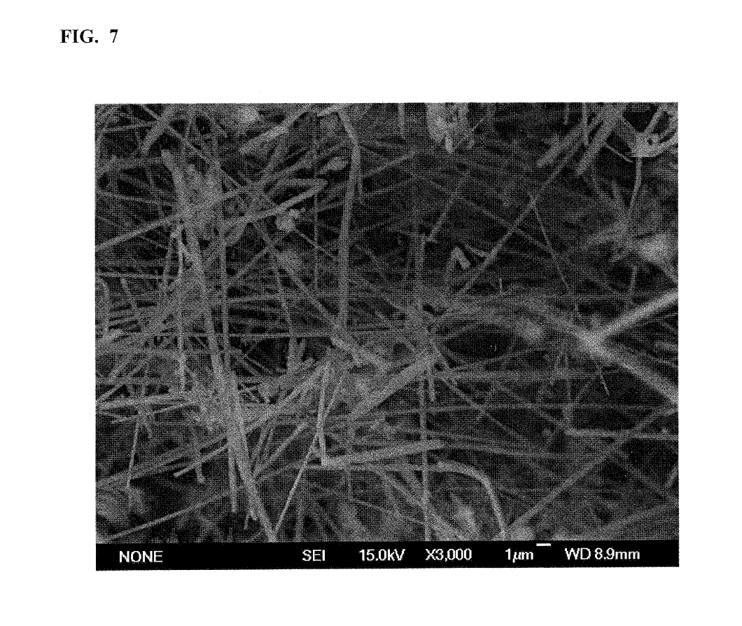

FIG. 7 illustrates exemplary silicon nitride nanostructures produced according to another embodiment. The exemplary silicon nitride nanostructure was produced from a combined carbon and silicon nitride feedstock of lignite comprising mineral ash as the silica source with additional silica and iron added to the feedstock. The particle size distribution of the feedstock was reduced by ball milling and ring milling the feedstock to produce a particle size distribution of about 3 mm. The feedstock was annealed at a temperature of 1370° C. for 4 hours in a continuous flow of nitrogen gas to produce the silicon nitride nanofibers illustrated in FIG. 7. The yield of silicon nitride nanofibers shown in FIG. 7 was increased by including iron in the feedstock.

Example embodiments have been described hereinabove regarding improved systems, methods and compositions for the production of silicon nitride nanostructures. Various modifications to and departures from the disclosed example embodiments will occur to those having ordinary skill in the art. The subject matter that is intended to be within the spirit of this disclosure is set forth in the following claims.

What is claimed is:

1. A method comprising:
preprocessing a carbon feedstock including carbonizing the carbon feedstock and reducing a particle size distribution of the carbon feedstock;
combining the carbon feedstock with a silicon feedstock to form a combined feedstock; and
annealing the combined feedstock in the presence of a nitrogen containing compound to produce a silicon nitride nanostructure.

2. The method as recited in claim 1, wherein preprocessing the carbon feedstock includes purifying the carbon feedstock.

3. The method as recited in claim 2, further comprising combining the carbon feedstock with a solvent to form a slurry.

4. The method as recited in claim 3, wherein the solvent is selected from the group consisting of: water, ethanol, pyridine, toluene, naphtha, hexane, kerosene, paraffinic solvents and combinations thereof.

5. The method as recited in claim 2, wherein purifying the carbon feedstock comprises at least one purification step in the group consisting of: ash removal, demineralization, swelling and ion exchange.

6. The method as recited in claim 1, wherein reducing the particle size distribution of the carbon feedstock comprises jaw crushing, hammer milling, ball milling, ring milling or a combination thereof.

7. The method as recited in claim 6, wherein reducing the particle size distribution of the carbon feedstock comprises reducing the particle size distribution of the carbon feedstock to less than or equal to 3 mm.

8. The method as recited in claim 1, wherein reducing the particle size distribution of the carbon feedstock comprises jaw crushing, hammer milling, ball milling or ring milling the carbon feedstock for less than or equal to 5 minutes.

9. The method as recited in claim 1, wherein reducing the particle size distribution of the carbon feedstock comprises reducing the particle size distribution of the carbon feedstock to less than or equal to 1 mm.

10. The method as recited in claim 5, wherein ion exchange comprises binding iron ions to the carbon feedstock.

11. The method as recited in claim 5, wherein ion exchange occurs at a temperature of about 70° C.

12. The method as recited in claim 1, wherein carbonizing the carbon feedstock comprises heating the carbon feedstock in the presence of a nitrogen containing compound.

13. The method as recited in claim 12, wherein carbonizing occurs at a temperature of about 500° C., for a time period of 1 to 5 hours and at atmospheric pressure.

14. The method as recited in claim 1, wherein the carbon feedstock is at least one compound selected from the group consisting of: lignite, sub-bituminous coal, bituminous coal, anthracite, graphite, sugar, wood, organic material, organic waste, carbon monoxide gas, natural gas, porous carbon, activated carbon, pitch, char and combinations thereof.

15. The method as recited in claim 1, wherein the silicon nitride nanostructures comprises at least one compound selected from the group consisting of: silicon, nitride, silicon oxynitride, silicon carbide and SiALON.

16. The method as recited in claim 1, further comprising preprocessing the silicon feedstock.

17. The method as recited in claim 16, wherein preprocessing the silicon feedstock comprises:
reducing a particle size distribution of the silicon feedstock;
washing the silicon feedstock; and
drying the silicon feedstock.

18. The method as recited in claim 17, wherein reducing a particle size distribution of the silicon feedstock comprises jaw crushing, hammer milling, ball milling, ring milling or a combination thereof.

19. The method as recited in claim 18, wherein reducing a particle size distribution of the silicon feedstock comprises reducing the particle size distribution of the silicon feedstock to a range between 20 to 60 microns.

20. The method as recited in claim 18, wherein reducing a particle size distribution of the silicon feedstock comprises reducing the particle size distribution of the silicon feedstock to less than or equal to 10 microns

21. The method as recited in claim 16, wherein the silicon feedstock is at least one compound selected from the group consisting of: high purity microsilica, sand, ash, microporous silica, geosilica, diatomite, mined silica, fumed silica, sub-mm silica, waste silica and combinations thereof.

22. The method as recited in claim 16, further comprising reducing a particle size distribution of the combined feedstock.

23. The method as recited in claim 22, further comprising purifying the silicon nitride nanostructure by acid washing the silicon nitride structure.

24. The method as recited in claim 22, wherein the silicon nitride nanostructures comprises at least one compound selected from the group consisting of: silicon, nitride, silicon oxynitride, silicon carbide and SiALON.
